(19) United States
(12) Patent Application Publication
(10) Pub. No.: US 2015/0333972 A1
(43) Pub. Date: Nov. 19, 2015

(54) SYSTEM AND METHOD FOR MANAGING HOSPITAL VIDEO AND DATA

(71) Applicant: Saint Louis University, St. Louis, MO (US)

(72) Inventor: Richard D. Bucholz, Ladue, MO (US)

(73) Assignee: Saint Louis University, St. Louis, MO (US)

(21) Appl. No.: 14/710,703

(22) Filed: May 13, 2015

Related U.S. Application Data
(60) Provisional application No. 61/992,612, filed on May 13, 2014.

(51) Int. Cl. H04L 12/24; G06F 3/0484

(52) U.S. Cl. CPC H04L 41/22; G06F 3/04847; G06F 3/04842

(57) ABSTRACT

A physician's console display presents physician icons which when selected by a physician causes a processor to execute software program applications stored in the memory device. Each software program accesses a component via a LAN. The components include an electronic health record server, equipment, and a PACS server. Each software program application provides an image generated by its component on the display of the physician's console. The processor executes a remote consultant communication protocol providing selected remote icons to the remote consultant's computer, each selected remote icon corresponding to one of the icons of the physician's console. When a particular remote icon is selected by a consultant via the remote consultant's computer, the remote consultant communication protocol provides the image generated by the component of the physician icon corresponding to the particular remote icon on the display of the remote consultant's computer.

### BACKGROUND

The management of stroke is highly time dependent, with a small window to intervene and break up a clot. Getting the expertise into a community hospital to make the decision as to start potentially risky clot busting medication (TPA) is problematic. Stroke experts indicate that they need access to various information such as the neurological examination (made possible by a video camera and microphone), the electronic health record (to check on glucose levels, anti-coagulation status, etc.) and the radiographic images (particularly the CT looking for intracranial hemorrhage), in order to assist in a decision making process.

The problem is quick and simultaneous access to the various information. Also, images normally stored on a picture archiving and communications system (PACS) are restricted to within the firewall of the community hospital and is not granted to outside consultants currently unless they can create a VPN into the hospital's LAN (requiring a username and password) in addition to a login to the health record and PACS (requiring two more username/password combinations). Setting up a consultant with three sets of usernames and passwords for each and every community hospital, and keeping them all straight and up to date (these have to be changed in a medical environment every 90 days) would be a huge administrative task, and the delay in entering all the required characters may delay implementation of expertise beyond the critical window.

### SUMMARY

Locally executing applications are treated as SURGical Operating room Network (SurgON) objects. SurgON objects include applications (e.g., applications for providing video and data) that run in a protected environment within the firewall of community hospitals (or ambulances, or med-evac aircraft).

Other objects and features will be in part apparent and in part pointed out hereinafter.

### BRIEF DESCRIPTION OF THE DRAWINGS

FIG. 1 is a block diagram of one embodiment of a system of the invention illustrating a shared video and data system in a local hospital environment with web-based control of data streams.

FIG. 2 is a block diagram of one embodiment of a system of the invention illustrating health records as SurgON objects in a local hospital environment.

FIG. 3 is a block diagram of one embodiment of a system of the invention illustrating drag and drop audio and/or video recording.

FIG. 4 is a block diagram of one embodiment of a system of the invention illustrating various hardware components, software, and drag and drop implementation of remote consultant computer icons.

Corresponding reference characters indicate corresponding parts throughout the drawings.

### DETAILED DESCRIPTION

According to aspects of embodiments of the invention, health records, equipment-generated images, and PACS images are handled as objects and are provided by the execution of icons. Thus, the SurgON systems and methods as described in U.S. Pat. Nos. 6,928,490 and 8,626,953, incorporated herein by reference, are expanded to cover health records and images as objects and to cover applications running on the SurgON controller located within the LAN of the community hospital. The local doctor has the ability to allow access to the images by using a graphical interface to drop an icon for the application onto the icon representing the remote consultant. The remote consultant would then have access to all information which is available to the local doctor via the local doctor's console.

Overview

In U.S. Pat. Nos. 6,928,490 and 8,626,953, the inventor delineated how communications can be facilitated within the operating room environment, and shared with external collaborators, using a standardized system based on web servers embedded in surgical devices interacting with a surgeon's control device to allow data and control streams to be shared with an external consultant.

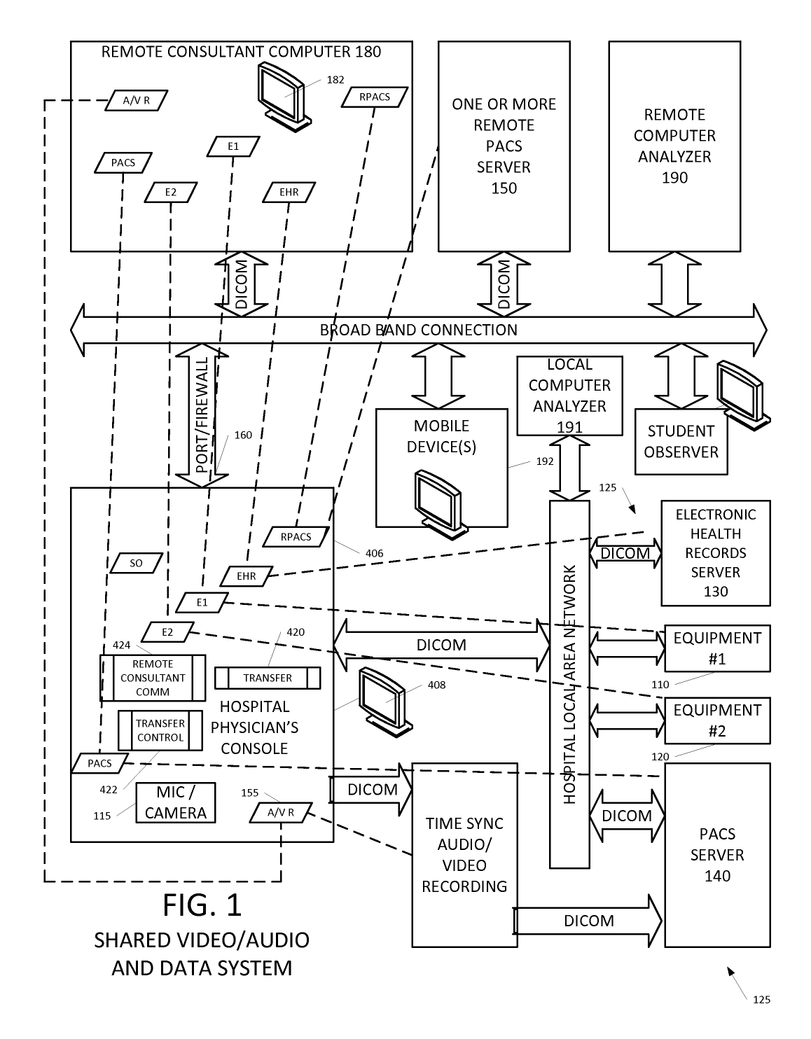

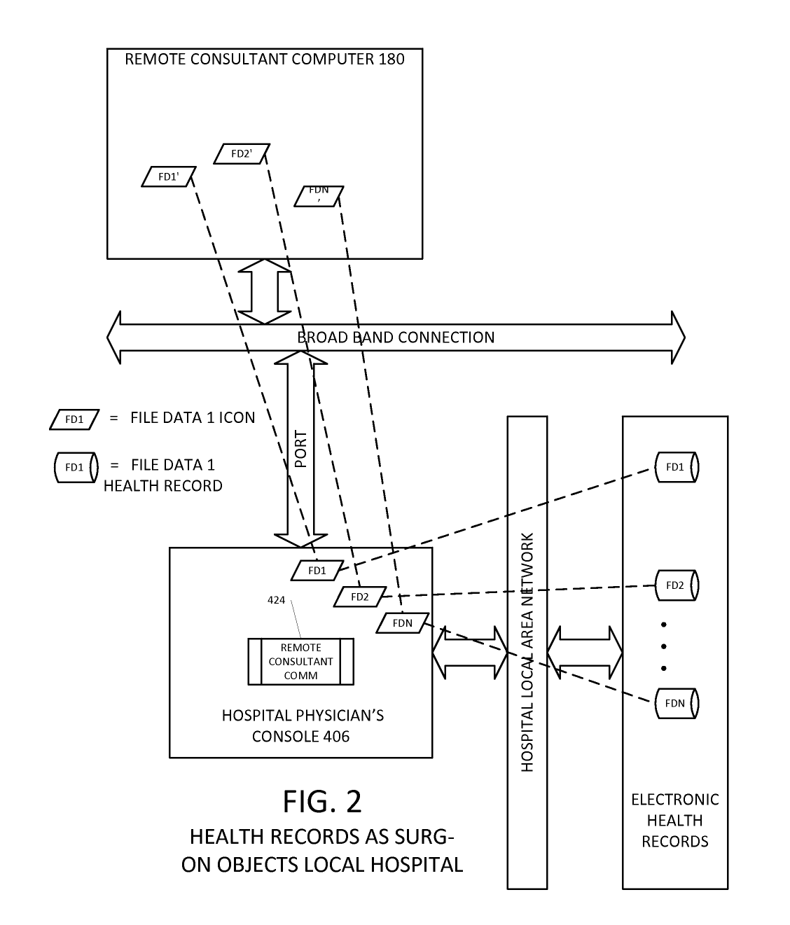

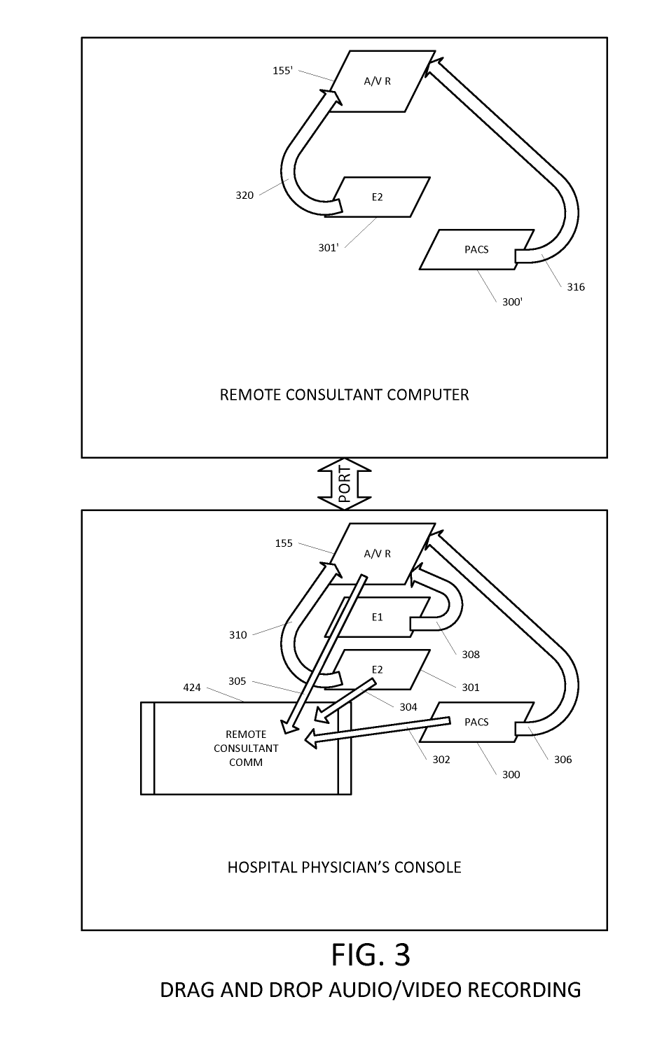

The systems and methods herein provide a mechanism by which video and audio experienced by a local physician can be shared with the remote consultant via a network and associated devices implementing a remote consultant communication protocol (see FIG. 1). In addition, the systems and methods herein are applicable to a local hospital dealing with an emergent situation and needing interaction with a remote consultant with expertise in the disease process currently being evaluated in which the remote consultant can simultaneously view information such as health records available to the local doctor (see FIG. 2). Also, the remote consultant as well as the local hospital physician has web based control of data streams (see FIGS. 1 and 3). Also, within a hospital LAN, health records, applications, and components generating images and/or data streams are handled as objects (see FIG. 1). Also, within a hospital LAN, the remote consultant as well as the hospital physician connected to the hospital LAN have drag and drop control of device data streams (see FIG. 3).

### Clinical Problem

Physicians in local community hospitals are frequently confronted with clinical situations that require immediate intervention to optimize outcome. These interventions are not without risk, and indeed in certain situations can result in additional deterioration in terms of outcome. Further, the interventions in many instances must be performed within a well-defined time interval after onset of the clinical problem. A good example of such a clinical situation is stroke, in which intervention can markedly improve eventual outcome. Yet, at the same time, some interventions in inappropriate situations can lead to worsened outcome or even death. The application of an intervention requires the input of a specialist who may not be available in the short time periods allowed for intervention due to geographic issues. Therefore, stroke represents one model for the benefits of telemedical intervention by a stroke specialist.

In discussing what sorts of information are important for a stroke specialist to determine an optimal intervention, some key pieces include the neurological examination, laboratory results based on blood analysis, physiological parameters such as blood pressure and oxygenation, and imaging. A major element of the neurological examination consists of visualization of how the patient is responding to questions which can be transmitted using video and audio of the local examination. The other parameters such as blood work, physiological parameters, and imaging are now frequently digitally encoded and stored on servers available to the local hospital network. For example, images are frequently stored on a PACS server within the hospital, blood work results are stored on the hospital's electronic health record, and physiological data from bedside monitors is streamed to remote workstations at work desks located in the critical care departments of the hospital. These applications are dependent on being within the firewall of the hospital, and applications that run on computers located on the local area network of the hospital. Being behind the firewall, this information is not easily shared with devices outside the firewall unless specific ports are made within the firewall to allow this communication, and the formation of these ports usually requires involvement of IT specialists and hospital administration to allow these ports to be opened. This process of opening ports clearly cannot address the time limitations seen within the treatment of a stroke patient, and having a dedicated opening to a specific machine does not address the fact that the remote consultant may not be at the remote machine open to the hospital LAN.

Therefore, a mechanism to allow a local physician the ability to share data applications running on local computers, while viewing the results of a neurological examination, is highly useful in addressing time sensitive problems such as the stroke clinical problem. The infrastructure described herein addresses this by suggesting a modification of the SurgON topography to allow data sharing, and to allow the creation of a wearable video device wirelessly connected to the local SurgON firewall to facilitate video and audio sharing.

Modification of SurgON topography

In U.S. Pat. Nos. 6,928,490 and 8,626,953, devices in the operating room were viewed as discrete devices which would communicate with the surgeon's portal via a web enabled interface. Systems and methods herein further extend the communication between the hospital physician and the remote consultant by providing applications running on the hospital physician's portal available to the remote consultant. For example, the PACS server, the electronic health record server, and the physiological data streaming application are depicted as separate entities actually running on the surgeon's portal or workstation, which is labeled herein as the local physician's console. These applications would be viewed as SurgON shareable devices, in that the local physician can grant access, via the local physician's console, to the running application to the remote consultant computer. Once granted, the remote consultant could review images, obtain the current physiologic parameters of an individual patient, and get blood work results coming from the laboratory about a specific patient, all without further interaction from the local physician.

One advantage of treating specific programs or applications running on the local console as SurgON shareable data sources is that the remote consultant can be free to obtain data as needed to optimize treatment. As the programs or applications are shareable SurgON data sources, each can be shared via a programmable firewall between the physician's console and the remote consultant's computer so that the local physician and/or the local console is free to grant, and rescind, access to this critical data on a moment by moment basis, and grant access to a specific consultant and/or a specific remote consultant computer.

As a result, access could be obtained to critical data in a time frame consistent with the clinical demands of a patient without requiring pre-arranged access. In an exemplary embodiment, the local physician's console facilitates substantially real-time data capture, control, and communication. Further, in one form the local physician's console, equipped with two network ports, is connected to both the hospital LAN, and an external leased broadband line, so that the hospital would not have to manage the ports being opened or closed, as this would all be managed by the local physician's console (e.g., local physician using a graphical user interface, computer-readable program instructions executing on the local physician console, etc.).

### Images Including Health Records as SURGON Objects (FIGS. 1, 2 and 4)

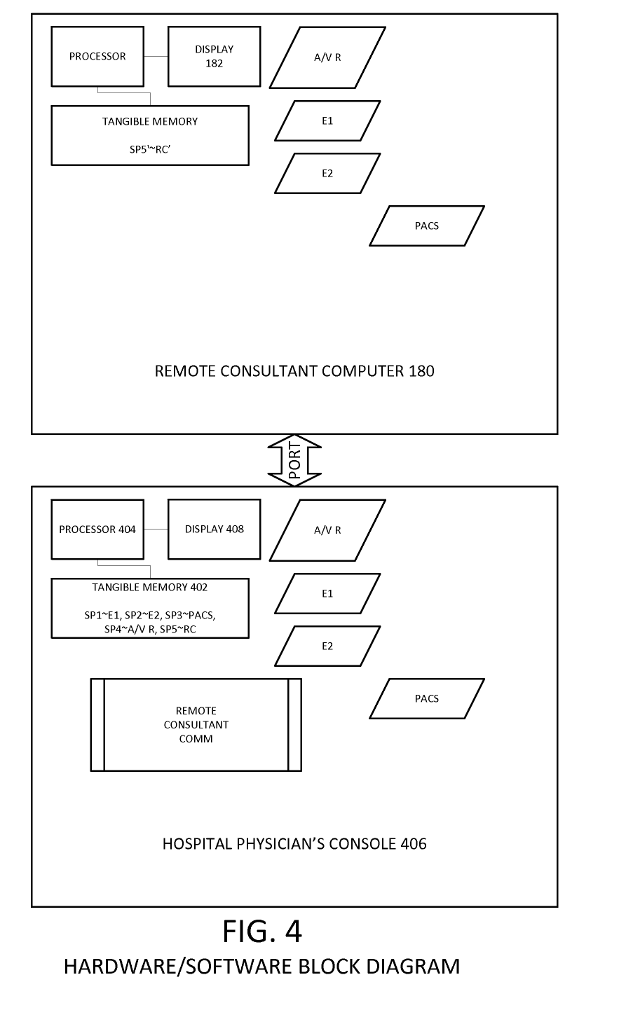

FIG. 1 is a block diagram of one embodiment of a system of the invention illustrating a shared video and data system in a local hospital environment with web-based control of data streams. FIG. 2 is a block diagram of one embodiment of a system of the invention illustrating health records as SurgON objects in a local hospital environment. FIG. 4 is a block diagram of one embodiment of a system of the invention illustrating various hardware components, and software, and drag and drop implementation of remote consultant computer icons.

As illustrated, a networking infrastructure is providing, including a non-transitory processor readable storage memory device 402, a processor 404 accessing the memory device 402, and a physician's console 406 having a touch-sensitive display 408 presenting physician icons. The icons may include equipment icons E1, E2 for accessing equipment 110 and equipment 120, an icon EHR for accessing an electronics health records server 130, a PACS server icon PACS for accessing a local PACS server 140, and/or a remote PACS server icon RPACS for accessing a remote PACS server 150.

The icons, when selected by a physician, cause the processor 404 to execute software program applications SP stored in the memory device. Each software program (e.g., SP1 for accessing equipment 110, SP2 for accessing equipment 120, SP3 for accessing the PACS server, SP4 for implementing A/V recording, and/or SP5 for implementing a remote consultant) accesses one component 125 via a LAN or implements an operation. The components 125 comprise but are not limited to an electronic health record server 130, equipment 110, 120, and a PACS server 140. For example, the equipment may be a microscope, gamma knife, bipolar coagulator, laser device, or other equipment for examining or treating patients. Each software program application SP when selected by the physician and executed by the processor 404 provides an image generated by its component on the display 408 of the physician's console 406.

The physician's console 406 includes a port 160 adapted to be securely connected via a broadband connection to a remote consultant's computer 180 having a display 182. The processor 404 is adapted to execute a remote consultant communication protocol SP5 providing selected remote icons to the remote consultant's computer 180. Each selected remote icon corresponds to one of the icons of the physician's console. As shown in FIG. 1, computer 180 includes icons which correspond to the icons of console 406. However, it is up to the physician to determine which icons appear and are available on the remote consultant's computer 180.

When a particular remote icon is selected by a consultant via the remote consultant's computer 180, the remote consultant communication protocol SP5 provides the image generated by the component of the physician icon corresponding to the particular remote icon on the display 182 of the remote consultant's computer. For example, if the remote consultant selects icon E1, the image provided by equipment 110 is provided to display 182. As illustrated, the infrastructure is configured so that the remote consultant communication protocol securely provides the image generated by the component of the physician icon via port 160 having a single firewall to the physician's console 140. This minimizes the need for the remote consultant's computer 180 to provide separate credentials to each of the secure servers and/or equipment being accessed. Exemplary secure communication protocols include, but are not limited to, Transmission Control Protocol (TCP), User Datagram Protocol (UDP), File Transfer Protocol (FTP), and token-based protocols, such as those described in U.S. Pat. No. 5,826,245, incorporated herein by reference.

It is also contemplated that the infrastructure can be configured to provide access to one or more remote PACS servers which are not part of the hospital LAN. The infrastructure of FIG. 1 wherein the physician's icon is securely connected via a broad band connection to a remote PACS server and wherein the remote consultant communication protocol securely provides images generated by the remote PACS server to the remote consultant's computer via the physician's console.

In one optional aspect, DICOM images are provided to the physician's console 406 from the electronic health record server 130, the PACS server and/or the remote PACS server. The DICOM images are provided from the physician's console 406 to the remote consultant's computer 180.

In one optional aspect, an auto record software program which automatically records images on the physician's console 406. For example, the auto record software program automatically records images on the physician's console as a function of a content of the image. As a specific example, an image or image stream of a critical surgical process or an important patient interview would cause automatic recording. In an aspect, image analysis software executing on processor 404 determines the content of the image and inserts a data header or other data field (such as a custom data structure or token) into the image data which is then read or detected by the auto record software program to initiate the automatic recording.

In one optional aspect, software would be implemented to allow file closure after a specific amount of time, upon action by either the local physician or remote consultant, or disconnection of one or more components 125 from console 406 or the computer 182.

In one optional aspect, the infrastructure is linked to a remote or local computer analyzer 190, 191 configured for remote or local computer analysis of the procedures and operations being displayed by the images presented on the displays of the console and/or the computer. In response to such analysis, computer analyzer 190, 191 provides information to the physician via audio output on a speaker of the console or video output on the console's display. For example, the infrastructure may be linked to a supercomputer such as IBM's WATSON® for continuously analyzing events and making recommendations or, in some cases, actually directing or controlling events. The supercomputer can turn on or off equipment such as an infusion pump at a particular time to assist the physician. This provides standardized analysis in real time of the events within the infrastructure.

It is also contemplated that the remote consultant's computer 180 can be a mobile device 192 having a touch sensitive display instead of or in addition to the computer 180.

FIG. 2 is a block diagram of one embodiment of a system of the invention illustrating health records as SurgON objects in a local hospital environment. In this configuration, each electronic health record file FD1, FD2, FDN is associated with a separate icon FD1, FD2, FDN, respectively. By dragging and dropping an icon on the remote consultant communication icon 424, a corresponding icon FD1′, FD2′, FDN′ is presented on the remote consultant's computer so that the consultant can view the files. In an aspect, local physician's console 406 communicates data to remote consultant computer 180 to enable the corresponding icon FD1′, FD2′, FDN′ such that the local physician's console overrides the normal expected manner of operation of the remote consultant computer (e.g., icons not available). The dashed lines in the figures are intended to indicate the association and correspondence of objects, icons, video, and file records.

### Video Streaming Device

One of the components 125 may comprise a video camera 115 worn by the physician or otherwise in proximity to the patient for creating an image stream of the patient and/or creating an image stream of the physician's actions. Sharing of applications connected to the hospital LAN may not fully address the need of a remote consultant to visualize the patient experiencing a stroke. To make this possible, attaching a video camera to the local physician or otherwise creating a real-time, live video stream of the patient would be helpful. This could be accomplished with an ear mounted video camera such as described by Looxcie. This device communicates with an Android operating system device to stream video and audio to the physician's console 406 in real time using a Bluetooth connection or other protocol.

The Android device would be a SurgON shareable device, in that video and audio streamed over the system would be recognized as a SurgON data source by the local physician's console 406. In an exemplary embodiment, the video and/or audio stream contains a data header or other data field identifying the data as a SurgON data source and the local physician's console 406 utilizes the data header or data field to recognize the steam as a SurgON data source. In one embodiment, the connection occurs over Wi-Fi implemented within the hospital; an alternative would be an Android smartphone device connected via either a 3G or 4G cellular network. The Android device would be configured to stream video and audio from the device in real time, and to allow the local physician to share this information with a remote consultant via a remote consultant communication icon 424 on the console 406, so that the remote consultant's computer 180 can see and hear the patient, as well as communicate using audio with the local physician.

### Recording

In one aspect, the physician's console includes a recording icon 155 (AN R) which when selected by a physician causes the processor 404 to execute a recording software program application stored in the memory device 402 which simultaneously records a first video stream from a first component (e.g., equipment E1) and simultaneously records a second video stream from a second component (e.g., equipment E2) in time synchronization with each other.

In one embodiment when the video stream is being provided to the remote consultant computer 180, the recording can be of the video stream being transmitted by the port/firewall 160 between the console 406 and the computer 180. In this context, the recording can be web based recording.

### Transfer of Control

In another embodiment, a separate transfer process is implemented so that the remote consultant “controls” the infrastructure as opposed to just monitoring the video/audio; in this way the remote consultant writes orders for tests needed for the evaluation, thereby freeing the local physician of this need, as the local physician may be busy taking care of the patient. In this way, the remote consultant can serve as a “co-pilot” in the management of the case, taking care of administrative details while the local physician does hands-on care. Thus, care is optimized given the expertise of the remote consultant, all without having to set up any specific passwords or usernames for the remote consultant to that particular hospital.

Initially and by default, the physician's console 406 has primary control of access to the images generated by the components 125 via the physician's icons and the remote consultant's computer 180 has secondary control of access to the images generated by the components 125 via the remote icons so that the physician's console 406 overrides the remote consultant's computer 180. As part of the transfer process, the physician's console 406 includes a transfer icon 420 which when selected by the physician causes the processor 404 to execute a control application adapted to transfer control from the physician's console 406 to the remote consultant's console 180. As a result of transfer, the remote consultant's computer 180 has primary control of access to the images generated by the components 125 via the remote icons and the physician's console 406 has secondary control of access to the images generated by the components 125 via the physician's icons such that the remote consultant's computer 180 overrides the physician's console 406.

The above addresses image control. It is also contemplated that total control can be transferred to the remote consultant's computer 180 so that all decision making and all access is primarily by the remote consultant's computer 180 via the physician's console 406. Initially and by default, the physician's console 406 has primary control of the components 125 via the physician's icons and the remote consultant's computer 180 has secondary control the components 125 via the remote icons so that the physician's console 406 overrides the remote consultant's computer 180. As part of the transfer process, the physician's console 406 includes a transfer control icon 422 which when selected by the physician causes the processor 404 to execute a control application adapted to transfer control from the physician's console 406 to the remote consultant's console 180. As a result of transfer, the remote consultant's computer 180 has primary control of the components 125 via the remote icons and the physician's console 406 has secondary control of the components 125 via the physician's icons such that the remote consultant's computer 180 overrides the physician's console 406. As a specific example, if one of the components 125 is a microscope, the remote consultant would have control of the microscope via the console 406 upon transfer.

### Drag and Drop Control of Data Streams

Medical interventions are increasingly accompanied by the production of data in a digital format. Examples include video obtained during endoscopy, digital still images taken during a procedure, amplifier traces obtained during deep brain recording, and physiological data obtained during monitoring for anesthesia. Currently, this data, if recorded at all, is saved to a variety of formats which pose several problems: capturing images to the electronic medical record may be difficult if no import function is implemented; the data files may overwhelm the ability of the electronic health record to contain them due to their size; this can lead to storing the data in some other form (local hard drive, CD ROM, USB drive, etc.) which can be either difficult to access for other practioners, lost, difficult to archive properly, or present a privacy risk.

Given the difficulty of capturing electronic health data, it is apparent that much of the data created during delivery of health care is simply not captured and is therefore lost for review by other practioners, quality review, or legal proceedings. By making data capture simple and secure, and insuring that only those with access to the medical record have access to the data storage medium, it can be expected that a much better record of the medical interaction will be maintained.

Thus, in one aspect, it is contemplated that the infrastructure comprises a remote consultant communication icon 424 corresponding to a remote consultant communication protocol. When selected by the physician, the icon 424 causes the processor 404 to execute the remote consultant communication protocol which securely links the computer 180 to the console 406.

When the physician drags and drops at 302 PACS icon 300 of PACS server 140 onto the icon 424, the remote consultant communication protocol provides to the display 182 of the remote consultant's computer 180 the image being generated by the PACS server 140 and/or provides a corresponding PACS icon 300′ which links to the image being provided.

When the physician drags and drops at 304 E2 icon 301 of equipment 120 onto the icon 424, the remote consultant communication protocol provides to the display 182 of the remote consultant's computer 180 the image being generated by the equipment 120 and/or provides a corresponding PACS icon 301′ which links to the image being provided.

When the physician drags and drops at 305 A/V R icon 155 for recording onto the icon 424, the remote consultant communication protocol provides to the display 182 of the remote consultant's computer 180 corresponding A/V R icon 155′ which allows the remote consultant to direct recording.

When the physician drags and drops at 306 PACS icon 300 of PACS server 140 onto the icon 155, the recording software program application stored in the memory device 402 is executed by processor 404 to initiate time sync recording of the image(s) being generated by the PACS server 140.

When the physician drags and drops at 308 the E1 icon of equipment 110 onto the icon 155, the recording software program application stored in the memory device 402 is executed by processor 404 to initiate time sync recording of the image(s) being generated by the equipment 110.

When the physician drags and drops at 310 the E2 icon of equipment 120 onto the icon 155, the recording software program application stored in the memory device 402 is executed by processor 404 to initiate time sync recording of the image(s) being generated by the equipment 120.

This drag and drop feature is also available to the remote consultant via the consultant's computer 180. Thus, when the remote consultant drags and drops at 316 PACS icon 300′ of PACS server 140 onto the icon 155′, the recording software program application stored in the memory device 402 is executed by processor 404 to initiate time sync recording of the image(s) being generated by the PACS server 140. When the remote consultant drags and drops at 320 the E2 icon of equipment 120 onto the icon 155′, the recording software program application stored in the memory device 402 is executed by processor 404 to initiate time sync recording of the image(s) being generated by the equipment 120.

As a result, one important aspect of the SurgON infrastructure is the easy manipulation of data streams during a medical intervention. By having each medical device in a therapeutic session networked, and having the data from the device placed on the network, the physician can gather together all data streams in one place on a central console for review and interaction. Data streams may include data indicative of significant parameters relating to the procedure or surgery being conducted by the physician. For example, the data streams may include the blood pressure and/or blood levels of a patient.

An additional feature of this data gathering is described above, namely, that of sharing any and or all of these data streams with a remote consultant computer. Sharing of the streams would be enabled simply by taking the icon for the data stream on the surgeon's console and dropping the icon on the icon of a remote consultant. This would create a link between the remote consultant computer and the source of information that would be maintained until broken by either the consultant or the local physician. Control streams, consisting of the current settings of a device and the ability to change these settings, could be shared in a similar fashion to allow the remote consultant to interact with the local devices by creating a link between the remote consultant computer and the local devices.

If SurgON is to be adapted to allow the recording of these data streams, rather than the sharing of data streams with a remote consultant, a device to record the data streams must be identified. Within the medical setting a logical choice for the autonomous receiving of such data streams with large file sizes already exists in the vast majority of institutions. The electronic health record, based upon alphanumeric recording of the medical chart, is poorly suited to maintain such large files; instead, the concept of the PACS server has been implemented at all major institutions to store radiographic images. The creation of PACS servers has been entirely based upon the adoption of a standard for storing such images termed DICOM.

Recently, the DICOM standard has been enhanced to handle all sorts of digital data types, including high definition video, audio, and other large data file types which are not suitable for storage within the electronic health record. As the images maintained in a PACS server are part of the medical record, access to the server is rigidly maintained to ensure patient privacy, and data is stored in redundant arrays of drives to prevent data loss. At the same time, access to these images is critical for the proper treatment of the patient, and most institutions have numerous portals to the PACS located everywhere in their campus, and have also implemented secure access from outside the campus of the medical center as well. Therefore, the PACS server is the ideal place for archiving large data files arising out of a medical intervention.

Thus, the infrastructure as described herein can be employed to “make the connection” from data creation to data creation through a simplified user interface.

### Recording Equipment Data Streams

It is also contemplated that the components may be generating a data stream indicating the status and setting of a component. A separate icon may be assigned to the data stream of a component. The data streams may be shared with the consultant and/or recorded, as noted herein. The data streams may be in additional to or instead of a video stream being generated by a component.

### An Example of Operating Room Implementation

The remote consultant icon and the recorder icon are activated by dropping one or more of the device icons representing each device in an operating room upon the remote consultant communication icon and the recorder icon. Instead of creating a hole in the therapeutic room firewall, the infrastructure herein opens a connection to the medical center PACS and equipment via the console. Files on the PACS server, the equipment images, and the recording data are individually created and handled as separate object. Multiple files would be created with distinct file names if multiple device icons are dropped upon the receiver icon. The DICOM system allows time stamping of files to allow synchronization between data files recorded from different devices. The file would be closed when the icon is moved off the receiver icon, or a button is pushed to pause recording the file, or the end of an epoch of time is reached, said epoch being determined by the local care giver upon initiation of the recording using a drop down or other menu. Further, the data steam of a device could be recorded by dropping an equipment icon onto the recording icon (or vice versa), allowing the review of the settings of the device during critical aspects of a medical intervention, such as an infusion rate for an intravenous pump, anesthetic settings during general anesthesia, or power settings of operative lasers.

The recording receiver icon could be implemented on any display, so that recording could be implemented from a nurse's display, the anesthesia display, or any other device within and connected to the treatment area. Further, the remote consultant would also have access to a recording icon, so that the remote consultant could record to a PACS at any point during a procedure. The target of the recording icon could either be the local hospital PACS, or a PACS connected anywhere on the Internet, to allow access from a wider audience if desired. The remote consultant communication icon could also be expanded to allow access to the files stored on the local or networked PACS server such that either the local care giver or the remote consultant could play back any recording on their display at any time during or after the procedure. It is anticipated that the playback of the recordings could be annotated by the playback software to allow comment on key aspects of the procedure.

### Summary

The system and method herein handles the issues surrounding data capture of medical information produced during a therapeutic intervention and facilitates the permanent capture of this information. The proposed infrastructure would seamlessly interact with any and all of the care giver devices, local and distant, in a medical interaction to record key points in a format accepted at all medical centers, and make certain the captured data was available to all practitioner devices with certified access to the PACS. The infrastructure would also use the considerable investment made by medical centers in their PACSs to capture key aspects of every intervention performed with the medical center.

It should be noted that the infrastructure is not only applicable for medical interventions but also for a variety of other situations including personal use in recording data streams emanating from the Internet or from other data sources. There are numerous situations in multiple industrial, commercial, or personal domains in which data streams are produced and lost unless directed to a recording system. The web based nature of the infrastructure lends itself to the easy manipulation and storage of data with a simple click and move of a mouse or finger on a touch sensitive array.

With the addition of a single computer in the Emergency Department of a local hospital, and a leased line to that single computer, the care of neurologically devastated patients could be optimized at very low cost; and with the addition of an inexpensive video camera and Android device, everything that a remote consultant needs to make a decision as to stroke intervention could be delivered in real time to the consultant. The resulting infrastructure fully addresses the needs for emergent care to be rendered locally by a generalist under the specific orders of a remote specialist with full access to all appropriate clinical data.

### Additional Optional Features

In one optional embodiment, an RFID or UWB tag is associated with each equipment 110, 120 so that the console 406 scans, identifies and tracks instruments within the proximity of the console. When a tag is detected, the console presents an icon corresponding to a software application for accessing and/or controlling the associated equipment. The RFID or UWB tag on one of the components identifies the component. The console 406 is configured to detect the tag and, in response to detecting the tag, the console's processor executes a software application for accessing and/or controlling the component.

In one optional embodiment, an optional video camera may be located in proximity of the physician for detecting physician's gestures. The processor 404 of the console 406 would be linked to the optional video camera for evaluating the gestures. Each detected gesture would correspond to an action by the physician so that the gestures would control the console without the need for the physician to touch the console or a mouse. The gesture control would be in addition to or in place of touch or voice controls.

In one optional embodiment, a student observer 196 having a display 197 may be linked via the broad band connection to communication between the console 406 and the computer 180. An optional student observer icon SO corresponding to a software application would allow the physician to provide to the observer 196 viewing rights only of the console display 172.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible, non-transitory processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

What is claimed is:

1. A networking infrastructure comprising:
a non-transitory processor readable storage memory device;
a processor accessing the memory device;
a physician's console having a display presenting physician icons which when selected by a physician cause the processor to execute software program applications stored in the memory device, each software program accessing one component via a LAN, wherein the components comprise an electronic health record server, an equipment, and a PACS server, wherein each software program application when selected by the physician and executed by the processor provides an image generated by its component on the display of the physician's console; and
wherein the physician's console has a port adapted to be securely connected via a broadband connection to a remote consultant's computer having a display,
wherein the processor is adapted to execute a remote consultant communication protocol providing selected remote icons to the remote consultant's computer, each selected remote icon corresponding to one of the icons of the physician's console, and
wherein, when a particular remote icon is selected by a consultant via the remote consultant's computer, the remote consultant communication protocol provides the image generated by the component of the physician icon corresponding to the particular remote icon on the display of the remote consultant's computer.

2. The infrastructure of claim 1 wherein the remote consultant communication protocol securely provides the image generated by the component of the physician icon via the physician's console.

3. The infrastructure of claim 1 further comprising a remote icon corresponding to the remote consultant communication protocol which, when selected by the physician, causes the processor to execute the remote consultant communication protocol and wherein the physician drags and drops a component icon of a particular component onto the remote icon to provide the image from the particular component to the display of the remote consultant's computer.

4. The infrastructure of claim 1 wherein the physician's console has primary control of access to the images generated by the components via the physician's icons and the remote consultant's computer has secondary control of access to the images generated by the components via the remote icons such that the physician's console overrides the remote consultant's computer, and
wherein said physician's console includes a transfer icon which when selected by the physician causes the processor to execute a control application adapted to transfer control from the physician's console to the remote consultant's console such that the remote consultant's computer has primary control of access to the images generated by the components via the remote icons and the physician's console has secondary control of access to the images generated by the components via the physician's icons such that the remote consultant's computer overrides the physician's console.

5. The infrastructure of claim 1 wherein the physician's icon is securely connected via a broad band connection to a remote PACS server and wherein the remote consultant communication protocol securely provides images generated by the remote PACS server to the remote consultant's computer via the physician's console.

6. The infrastructure of claim 1 wherein DICOM images are provided to the physician's console from an electronic health record server and wherein the DICOM images are provided from the physician's console to the remote consultant's computer.

7. The infrastructure of claim 1 further comprising an auto record software program which automatically records images on the physician's console or an auto record software program which automatically records images on the physician's console as a function of a content of the image.

8. The infrastructure of claim 7 wherein at least one of the following:
each software program accessing a component executes file closure of the after a specific amount of time, upon action by either the physician or the remote consultant, or disconnection of one or more components from the console or the computer.

9. The infrastructure of claim 1 further comprising a remote or local computer analyzing images presented on the physician's console and, in response to such analysis, providing information to the physician via audio or video output.

10. The infrastructure of claim 1 wherein the physician's console has primary control of the components via the physician's icons and the remote consultant's computer has secondary control of the components via the remote icons such that the physician's console overrides the remote consultant's computer, and
wherein said physician's console includes a transfer icon which when selected by the physician causes the processor to execute a control application adapted to transfer control from the physician's console to the remote consultant's console such that the remote consultant's computer has primary control of the components via the remote icons and the physician's console has secondary control of the components via the physician's icons such that the remote consultant's computer overrides the physician's console.

11. The infrastructure of claim 1 comprising the following:
wherein the remote consultant's computer comprises a mobile device;
wherein one of the components comprises a video camera creating an image stream of the patient;
a RFID or UWB tag on one of the components to identifying the component wherein the console is configured to detect the tag and, in response to detecting the tag, the console's processor executes a software application for accessing and/or controlling the component.

12. A networking infrastructure comprising:
a non-transitory processor readable storage memory device;
a processor accessing the memory device;
a physician's console having a display presenting a physician icon which when selected by a physician cause the processor to execute software program application stored in the memory device, the software program accessing an electronic health records server, wherein the software program application when selected by the physician and executed by the processor provides an image generated by the electronic health record server on the display of the physician's console; and
wherein the physician's console has a port adapted to be connected via a broadband connection to a remote consultant's computer having a display,
wherein the processor is adapted to execute a remote consultant communication protocol providing a remote icon to the remote consultant's computer, the remote icon corresponding to the physician icon, and
wherein, when the remote icon is selected by a consultant via the remote consultant's computer, the remote consultant communication protocol provides the image generated by the electronic health records server on the display of the remote consultant's computer.

13. The infrastructure of claim 12 wherein the remote consultant communication protocol securely provides the image generated by the electronic health record server via the physician's console.

14. The infrastructure of claim 12 further comprising a remote icon corresponding to the remote consultant communication protocol which, when selected by the physician, causes the processor to execute the remote consultant communication protocol and wherein the physician drags and drops the electronic health record server onto the remote icon to provide the image from the electronic health record server to the display of the remote consultant's computer.

15. The infrastructure of claim 12 wherein the physician's icon is securely connected via a broad band connection to a remote PACS server and wherein the remote consultant communication protocol securely provides images generated by the remote PACS server to the remote consultant's computer via the physician's console.

16. The infrastructure of claim 12 wherein DICOM images are provided to the physician's console from the electronic health record server and wherein the DICOM images are provided from the physician's console to the remote consultant's computer.

17. A networking infrastructure comprising:
a non-transitory processor readable storage memory device;
a processor accessing the memory device;
a physician's console having a display presenting physician first and second icons which when selected by a physician cause the processor to respectively execute first and second software program applications stored in the memory device, each software program accessing one component via a LAN, wherein the components comprise a first equipment and a second equipment,
wherein the first software program application when selected by the physician and executed by the processor presents on the display a first video stream generated by the first equipment,
wherein the second software program application when selected by the physician and executed by the processor presents a second video stream generated by the second equipment, and
wherein the physician's console includes a recording icon which when selected by a physician causes the processor to execute a recording software program application stored in the memory device which simultaneously records the first video stream and the second video stream in time synchronization with each other.

18. The infrastructure of claim 17 further comprising a remote recording icon which, when selected by the physician, causes the processor to execute a remote recording software program recording images presented on the display of the physician's console and wherein the physician drags and drops a component icon of a particular component onto the remote recording icon to record the image from the particular component.

19. The infrastructure of claim 17 further comprising a remote recording icon which, when selected by the remote consultant, causes the processor to execute a remote recording software program recording images presented on the display of the remote consultant's console and wherein the remote consultant drags and drops a component icon of a particular component onto the remote recording icon to record the image from the particular component.

20. The infrastructure of claim 17 wherein the physician's console has a port adapted to be connected via a broadband connection to a remote consultant's computer having a display,
wherein the physician's console has a port adapted to be connected via a broadband connection to a remote consultant's computer having a display,
wherein the processor is adapted to execute a remote consultant communication protocol providing a remote icon to the remote consultant's computer, the remote icon corresponding to the physician icon, and
wherein, when the remote icon is selected by a consultant via the remote consultant's computer, the remote consultant communication protocol provides the image generated by the electronic health records server on the display of the remote consultant's computer.

21. The infrastructure of claim 17 wherein the physician's console has a port adapted to be connected via a broadband connection to a remote consultant's computer having a display,
wherein the physician's console has a port adapted to be securely connected via a broadband connection to a remote consultant's computer having a display,
wherein the processor is adapted to execute a remote consultant communication protocol providing selected remote icons to the remote consultant's computer, each selected remote icon corresponding to one of the icons of the physician's console, and
wherein, when a particular remote icon is selected by a consultant via the remote consultant's computer, the remote consultant communication protocol provides the image generated by the component of the physician icon corresponding to the particular remote icon on the display of the remote consultant's computer.
